(19) United States
(12) Patent Application Publication
(10) Pub. No.: US 2007/0175929 A1
(43) Pub. Date: Aug. 2, 2007

(54) Systems and kits for enabling fluids to be effectively dispensed from a distance

(76) Inventor: Terry L. Schram, Marcellus, NY (US)

Correspondence Address: MARJAMA & BILINSKI LLP, 250 SOUTH CLINTON STREET, SUITE 300, SYRACUSE, NY, 13202, US

(21) Appl. No.: 11/345,919

(22) Filed: Feb. 2, 2006

(51) Int. Cl. B67D 3/00

(52) U.S. Cl. 222/527; 138/120; 138/155

(57) ABSTRACT

Systems and kits for enabling or facilitating one to introduce fuel from a fuel source into a fuel receiving area while being remotely positioned from the fuel receiving area are provided, wherein such systems and kits include one or more segments of articulated hose or tubing and can further include one or more adapters placed into communication with one or each of the fuel source and the fuel receiving area as well as one end of the hose or tubing.

### FIELD OF THE INVENTION

This invention relates in general to fuel dispensing systems, and, more particularly, to systems for transferring the contents of a fuel source to a fuel receiving area located away from the fuel source, and, still more particularly, to systems for enabling motorists to transfer the contents of a gasoline container to the gasoline tank of their vehicles while on a roadside yet at a distance safely remote from oncoming traffic.

### BACKGROUND OF THE INVENTION

Most drivers unintentionally run out of gasoline at some point during their lifetime, usually due to their inattentiveness, their inability to locate a service station in time, and/or because of a malfunctioning gasoline gauge. Fearing this, many drivers maintain a canister or other container in their vehicle in which they keep (or can insert) a few gallons of gasoline, which usually is more than enough to put in a vehicle's gasoline tank to allow the driver to drive his or her vehicle to a service station. To fill a gasoline tank using one of these containers, the driver first opens the gas intake area of his or her vehicle and unscrews a cover to reveal the gasoline tank opening. The driver then pours some or all of the gasoline from within the container into the gasoline tank.

Although this filling process only takes a short time, the driver is forced to hold the container in place during its entire duration because the weight of the gasoline within the container would otherwise cause the container to fall to the ground, thus discontinuing the process. Unfortunately, while a driver is holding the container in place as such he or she is vulnerable to oncoming traffic because the gasoline tank opening is located on either the side or the rear of most vehicles currently being driven.

For example, if a vehicle runs out of gas on a busy highway, its driver generally will be able to safely coast into the breakdown lane (or other area out of, but still near oncoming traffic) before his/her car comes to a complete stop. However, if the gas tank opening is on the left side or rear of the driver's vehicle, as it quite often is, that means the driver will have nothing separating his or her body from oncoming traffic during the filling process. And alas, despite the fact that the filling process rarely takes more than a few minutes, there have been documented instances where drivers have been seriously harmed or killed when in this vulnerable filling position due to being sideswiped or run into by another vehicle.

Although there are known systems that enable one to remotely input fuel into a fuel receiving area, such systems have encountered problems in use and, for one or more reasons, would be unsuitable for addressing the aforementioned problems. For example, U.S. Pat. No. 6,006,961 to Wark discloses (see, e.g., FIG. 4) an adapter 14 for attaching a quantity of flexible hose 16 between a fuel tank for a motorboat 36 and a fuel can 10 to enable fuel from the fuel can to be remotely dispensed into the boat's fuel tank. As is also depicted in FIG. 4, however, due to its flexibility the quantity of flexible hose 16 tends to sag under its own weight or that of the flowing fuel, thus interfering with a gravity fill of the fuel tank. That causes the fuel to pool within the sagging portion of the hose 16 such that little, if any, fuel ultimately would reach the fuel tank unless the person using the system maneuvered or otherwise adjusted the hose, which, in turn, would defeat the purpose of being able to remotely dispense fuel into a fuel tank.

Various other filling systems are described in U.S. Pat. Nos. 4,548,344 to Hestehave et al., 4,921,147 to Poirier, 5,553,750 to Foster, and 6,068,163 to Kihm, but they too can suffer from sagging, plus other problems such as kinking, improper dimensions and/or inability to be used with ignitable fuels.

Thus, there remains a need for a system that would enable or facilitate a driver to be located more remote from oncoming traffic while still being able to fuel or refuel his or her vehicle with gasoline or other fuel from a spare canister or other container while on a roadside or other area in which the driver would otherwise be vulnerable to oncoming traffic during the (re)fueling process.

### SUMMARY OF THE INVENTION

These and other needs are met by the present invention, which provides systems and kits to enable or facilitate the process dispensing fuel from a fuel source (e.g., a spare gasoline container) into a fuel receiving area (e.g., the fuel intake area of a vehicle) while being situated remotely from the fuel receiving area. Thus, by way of non-limiting example, the systems and kits of the present invention, in use, beneficially allow one whose vehicle has run out of gas on a roadside to introduce gasoline into the vehicle while being situated away from oncoming traffic during the refueling process.

In accordance with an exemplary aspect of the present invention, such a remote fuel dispensing system comprises a plurality of reversibly connected (e.g., by ball and socket connections) articulatable hose segments, wherein each hose segment has a lumen defining a fluid pathway therein. Each hose segment can be comprised, by way of non-limiting example, of a plurality of reversible connected (e.g., by ball and socket connections) subsegments.

The remote fuel dispensing system further includes a fuel receiving area adapter attached to a first end of the plurality of hose segments for placement into the fuel receiving area. By way of non-limiting example, the fuel receiving area adapter can be a tubular member which has a first end, a second end and a lumen, wherein the lumen defines a fluid pathway between the first end and the second end of the fuel receiving area adapter.

Moreover, the remote fuel dispensing system can be comprised of various other components as well, if desired. For example, the system can include an intermediary element for placement between the fuel receiving area adapter and the plurality of articulated hose segments. To that end, the intermediary element can have a first end, a second end and a lumen, wherein the lumen defines a fluid pathway between the first end and the second end of the intermediary element. The first end of the intermediary element can be connected (e.g., by a ball and socket connection) to the first end of one of the plurality of articulated hose segments and the second end of the intermediary element can be disposed within, and, if desired, connected to (e.g., through use of an adhesive) the fuel receiving area adapter.

Also, the system can further comprise a fuel source adapter attached to a second end of the plurality of hose segments and in communication with a fuel source. The adapter itself can be comprised of a single element or a plurality of connected elements. An intermediary element can be disposed between the fuel receiving area adapter and the plurality of articulated hose segments. For example, the intermediary element can have a first end, a second end and a lumen, wherein the lumen defines a fluid pathway between the first end and the second end of the intermediary element, and wherein the first end of the intermediary element is connected to the second end of one of the plurality of articulated hose segments, and wherein the second end of the intermediary element is connected to the fuel receiving area adapter.

The remote fuel dispensing system can still further include a valve element, which has a first end, a second end and a lumen, wherein the lumen defines a fluid pathway between the first end and the second end of the valve element. By way of example, the first end of the valve element can be connected to the first end of the intermediary element and the second end of the valve element can be connected to the second end of one of the plurality of articulated hose segments.

The remote fuel dispensing system can yet still further include one or more seal elements, either or both of which can be disposed, by way of non-limiting example, on the second adapter. Suitable such seals include, but are not limited to, slip joint washers and O-rings.

In accordance with another exemplary aspect of the present invention, a kit is provided and includes components to enable or facilitate remotely dispensing fuel from a fuel source to a fuel receiving area. Such components can include, but are not limited to: a plurality of articulatable hose segments, at least some of which are adapted to be reversibly connected to one another; at least one fuel receiving area adapter attachable to a first end of the plurality of hose segments for placement into a fuel receiving area; at least one fuel source adapter attachable to a second end of the plurality of hose segments for placement into a fuel source; at least one intermediary element adapted to be disposed between the first end of the plurality of hose segments and the fuel receiving area; at least one intermediary element adapted to be disposed between the second end of the plurality of hose segments and the fuel source; at least one valve element adapted to be disposed between the second end of the plurality of hose segments and the fuel source; and at least one seal adapted to be disposed on the second adapter.

Still other aspects, embodiments and advantages of the present invention are discussed in detail below.

### BRIEF DESCRIPTION OF THE DRAWINGS

For a fuller understanding of the nature and desired objects of the present invention, reference is made to the following detailed description taken in conjunction with the accompanying figures, wherein like reference characters denote corresponding parts throughout the views, and in which:

FIG. 1 is a top view of an exemplary hose/tubing segment in accordance with the present invention;

FIG. 2A is top view of the open, ball-type end of a subsegment of the hose/tubing segment of FIG. 1;

FIG. 2B is top view of the open, socket-type end of a subsegment of the hose/tubing segment of FIG. 1;

FIG. 3 is an exploded view of a fuel source adapter and intermediary element in accordance with an exemplary embodiment of the present invention;

FIG. 4 is a top view of an exemplary fueling system of the present invention incorporating elements shown in FIGS. 1-3;

FIG. 5 is an exploded view of a fuel source adapter and intermediary element in accordance with another exemplary embodiment of the present invention;

FIG. 6 is a top view of the adapter of FIG. 5 with the addition of an optional valve element and having been connected to a fuel container;

FIG. 7 is a top view of the adapter of FIG. 5 with the addition of two optional sealing elements;

FIG. 8 is a top view of an exemplary fueling system of the present invention incorporating elements shown in FIGS. 5-7; and

FIG. 9 is a top view of an exemplary fueling system of the present invention that is intended for use in CARB compliant jurisdictions.

### DETAILED DESCRIPTION

The present invention is directed to systems and kits to enable or facilitate the dispensing of fluid from a fluid source into a fluid receiving area while being positioned remotely from the fluid receiving area. The systems and kits include a plurality of segments of hose, which can be connected (or are pre-attached) to each other to form an articulated element and to which one or more adapters can be connected or attached in order to enable or facilitate the system acting as a conduit for transferring the fluid from the fluid source to the fluid receiving area.

The term “fluid,” as used herein, can refer to any liquid or a gas; including, by way of non-limiting example, a fuel, wherein exemplary “fuels” can include, but are not limited to gasoline, diesel fuel, biodiesel fuel, ethanol, gasohol, methanol, natural gas and petroleum. The term “receiving area” refers to a fluid intake area, such as, by way of non-limiting example, the fuel intake area of a vehicle, wherein the term “vehicle” refers to, also by way of non-limiting example, machinery or a mode of transport that is operated through use of, or that can make use of fuel, e.g., an automobile, a motorcycle, a motorized scooter, a truck, a bus, a lawnmower, a motorhome or mobile home, a motorboat or a golf cart.

The term “fluid source” refers to a container or area in which fluid is stored and/or from which fluid can be dispensed or otherwise removed. One of the benefits of the present invention is that it can be utilized with a wide range of “fluid sources” of various different sizes and shapes and that are made of various materials and by various manufacturers. By way of non-limiting example, the “fluid source” can be a portable or transportable fuel container, such as a plastic or metal gasoline can. Examples of such suitable gasoline cans include, but are not limited to plastic or metal gas cans sold by or under the name of Gott, Rubberrnaid, Blitz, Wedco, Eagle, Scepter, Chilton, Midwest, Sears and Echo.

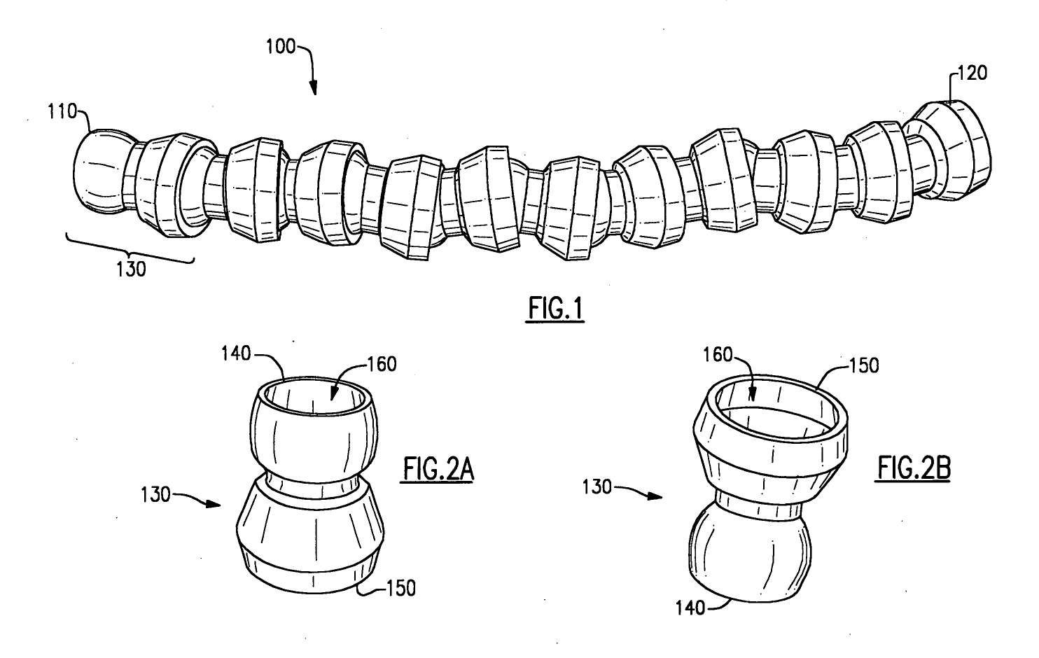

Referring initially to FIG. 1, a segment 100 of hose or tubing is shown, wherein the segment 100 has a first end 110 and a second end 120. Each hose segment 100 is comprised of a plurality of attachable or pre-attached hose subsegments 130. An exemplary subsegment 130 is shown in FIGS. 2A and 2B, wherein each subsegment has an open first end 140 and an open second end 150 and a lumen 160 defining a fluid pathway therebetween. Because each hose subsegment 130 has a fluid pathway defined therein, so too will the hose segment 100—that is, a segment 100 of connected subsegments will have a fluid pathway defined between its first end 110 and its second end 120.

In accordance with an exemplary embodiment of the present invention, and as illustrated in FIGS. 2A and 2B, the first end 140 of each subsegment 130 of the hose/tubing segment 100 is a ball-type end and the second end 150 of each subsegment is a socket-type end. The ball-type end 140 of each subsegment 130 is sized and shaped to fit within the socket-type end 150 of each subsegment so as to provide a fluid tight connection between connected subsegments. A plurality of subsegments 130 can be attached or connected in this “ball and socket” manner to form a chain of subsegments, which, as connected, form a segment 100 of the type shown in FIG. 1.

Because the segment 100 of FIG. 1 is formed of a chain of connected ball and socket subsegments 130 of the type shown in FIGS. 2A and 2B, one end of the segment will be a ball-type end and the other end of the segment will be a socket-type end. In the FIG. 1 exemplary embodiment, the first end 110 of the segment 100 is a ball-type end and the second end 120 of the segment is a socket-type end. This enables the segment 100 of FIG. 1 to be connectable to other (sub)segments so as to form a chain of connected segments. Once connected as such, the segments 100 will have two free ends such that still other segments (not shown) can be connected in the same manner in order to add additional segments to the chain of segments so as to lengthen the chain. Moreover, each additional connected segment can have a yet additional segment attached to its free end, thus enabling the chain to continue to grow as desired.

Although not illustrated, it is understood that first and second ends 110, 120 of the segment(s) 100 of FIG. 1 and/or first and second ends 140, 150 of one or more subsegments 130 of the type shown in FIGS. 2A and 2B can be adapted to be connectable to other segments/subsegments via other techniques. By way of non-limiting example, the first end 110 of the segment(s) 100 and/or the first end 140 of one or more subsegments 130 can include internal or external male threads and the second end 120 of the segment(s) 100 and/or the second end 150 of one or more subsegments 130 can include internal or external female threads (or vice versa), such that each end can be threaded to the complimentarily threaded other end in order to form chains of connected segments and/or subsegments.

In accordance with an exemplary embodiment of the present invention, each segment 100 of FIG. 1 includes eleven subsegments 130 (e.g., of the type shown in FIGS. 2A and 2B), wherein each segment 100 has a length of about eleven inches. It is understood, however, that each segment 100 can include greater or less than eleven subsegments 130 and can have a length greater than or less than eleven inches, e.g., as a matter of design choice or in order to lengthen or shorten the segment 100. Moreover, if a plurality of segments 100 are attached to one another as described above, each attached segment can include the same total number of subsegments 130 (e.g., eleven) or a different total number of subsegments (e.g., eleven, more than eleven, fewer than eleven).

In accordance with an exemplary embodiment of the present invention, each segment 100 and each subsegment 130 is made of a plastic-based material having one or more of the following materials properties: high rigidity, mechanical strength, good elasticity, high toughness, dimensional stability, excellent sliding friction, and excellent chemical resistance (including with respect to fuels such as gasoline and diesel fuel). Suitable such plastic-based materials include, but are not limited to, acetal-based polymers such as acetal polyoxymethylene, which is commercially manufactured by BASF Corporation of Wyandotte, Wis. USA and sold under the trademark ULTRAFORM®. In accordance with an exemplary embodiment of the present invention in which the fluid is a fuel such as gasoline or diesel fuel, a suitable acetal polyoxymethylene material from which the segment 100 and subsegments 130 can be made is, by way of non-limiting example, ULTRAFORM® N 2320 003 UNC Q600. Exemplary segments 100 made of such material are commercially available as item numbers 34000 and 34001 from Wiha Quality Tools of Monticello, Minn. USA.

Segments 100 and subsegments 130 can be attached to and detached from one another as desired through the use of one or more tools (not shown). By way of non-limiting example, a segment 100 can be attached to another (sub)segment and/or a subsegment 130 can be attached to another (sub)segment through use of a tool, wherein a suitable such tool is an assembly pliers tool commercially available as item number 34044 from Wiha Quality Tools of Monticello, Minn. USA. Also by way of non-limiting example, assembled segments 100 can be disassembled into smaller segments or subsegments 130 and/or subsegments 100 can be disassembled into still smaller subsegments through use of a wedge tool, wherein a suitable such tool is a separation wedge tool commercially available as item number 34042 from Wiha Quality Tools of Monticello, Minn. USA.

In accordance with an exemplary embodiment of the present invention, a hose/tubing segment 100 or chain of connected segments 100 are utilized to enable or facilitate the dispensing of fluid from a fluid source into a fluid receiving area while being positioned remotely from the receiving area. To further enable or facilitate this process, one or more adapters can be attached, connected or otherwise placed into communication with the hose/tubing segment(s).

In accordance with an exemplary embodiment of the present invention, a first, fuel receiving area adapter 200 is attached or connected to a device (e.g., to either end 110, 120 of a hose segment 100) so as to enable or facilitate the introduction of fluid (e.g., fuel) into a fuel receiving area (e.g., a fuel intake tank of a vehicle). By way of non-limiting example, and as illustrated in FIG. 4, the first adapter 200 can be a tubular member having a proximal end 210, a distal end 220 and a lumen (not shown) defining a fluid pathway therebetween. The proximal end 210 of the tubular member 200 is adapted for placement into a fuel receiving area (e.g., the fuel tank of a vehicle), and the distal end 220 is adapted to be connected to an end of a hose segment 100 either directly or, as shown in FIG. 4, via an intermediary element 230.

In accordance with an exemplary embodiment of the present invention in which an intermediary element 230 is utilized, and as illustrated in FIG. 4, a suitable intermediary element can be, by way of non-limiting example, an extension spout with a lumen (not shown) defining a fluid pathway therethrough. As shown in FIG. 4, the extension spout 230 can be inserted within the distal end 220 of the tubular member 200 such that at least a portion of the cylindrical main body 240 of the extension spout is disposed within the lumen of the tubular member. The extension spout 230 has a distal end 250 that is in the form of a female socket, wherein the socket can be connected or attached to the ball end 110 of a hose segment 100 via techniques and through use of equipment as described above.

In accordance with an exemplary embodiment of the present invention, both the tubular member 200 and the extension spout 230 are made of plastic-based material, wherein such a material can be the same or different. By way of non-limiting example, the tubular member can be made of a polyvinylchloride (PVC) material, wherein suitable such PVC materials include but are not limited to Carlon® Schedule 40 type PVC material, which is commercially available from Lamson & Sessions of Cleveland, Ohio USA. Also by way of non-limiting example, the extension spout 230 can be made of an acetal-based polymer such as acetal polyoxymethylene, which is commercially manufactured by BASF Corporation of Wyandotte, Wis. USA and sold under the trademark ULTRAFORM®. In accordance with an exemplary embodiment of the present invention in which the fluid is a fuel such as gasoline or diesel fuel, a suitable acetal polyoxymethylene material from which the extension spout 230 can be made is, by way of non-limiting example, ULTRAFORM® N 2320 003 UNC Q600. Exemplary extension spouts 230 made of such material are commercially available as item number 34046 from Wiha Quality Tools of Monticello, Minn. USA.

In an embodiment wherein an intermediary element 230 (e.g., an extension spout) is utilized, it should be connected to the tubular member 200 via a connection technique that ensures a fluid-tight connection and through use of materials and/or devices that do not chemically react with fuels. By way of non-limiting example, the tubular member 200 and the extension spout 230 can be connected through use of an adhesive, wherein suitable adhesives include, but are not limited to Carlon® low VOC solvent cement, which is commercially available under part number VC9LV4 from Lamson & Sessions of Cleveland, Ohio USA.

In accordance with an exemplary embodiment of the present invention, a second adapter is attached or connected to an end of a hose segment 100 (e.g., whichever end 110, 120 of the hose segment 100 to which the first adapter 200 is not attached). Whereas a purpose of the first adapter 200 was to enable or facilitate the introduction of fluid into a fluid receiving area, a purpose of the second adapter is to enable or facilitate connection of the hose/tubing segment 100 to a fuel source. Thus, once the second adapter is connected or attached to or otherwise placed into communication with the tubing segment(s) 100, a complete fluid pathway will be defined from the fuel source to fuel receiving area.

The design of the second adapter and/or how it is connected to a tubing segment 100 generally will vary depending on the type of fuel source and/or the material from which the fuel source is made. In accordance with an exemplary embodiment of the present invention in which the fuel source is a container or canister in which fuel is or can be stored (e.g., a gasoline can), at least the design of the second adapter will vary depending on whether the canister is made of plastic or metal, and/or whether the fuel source is to be used in a California Air Resources Board (CARB) compliant jurisdiction.

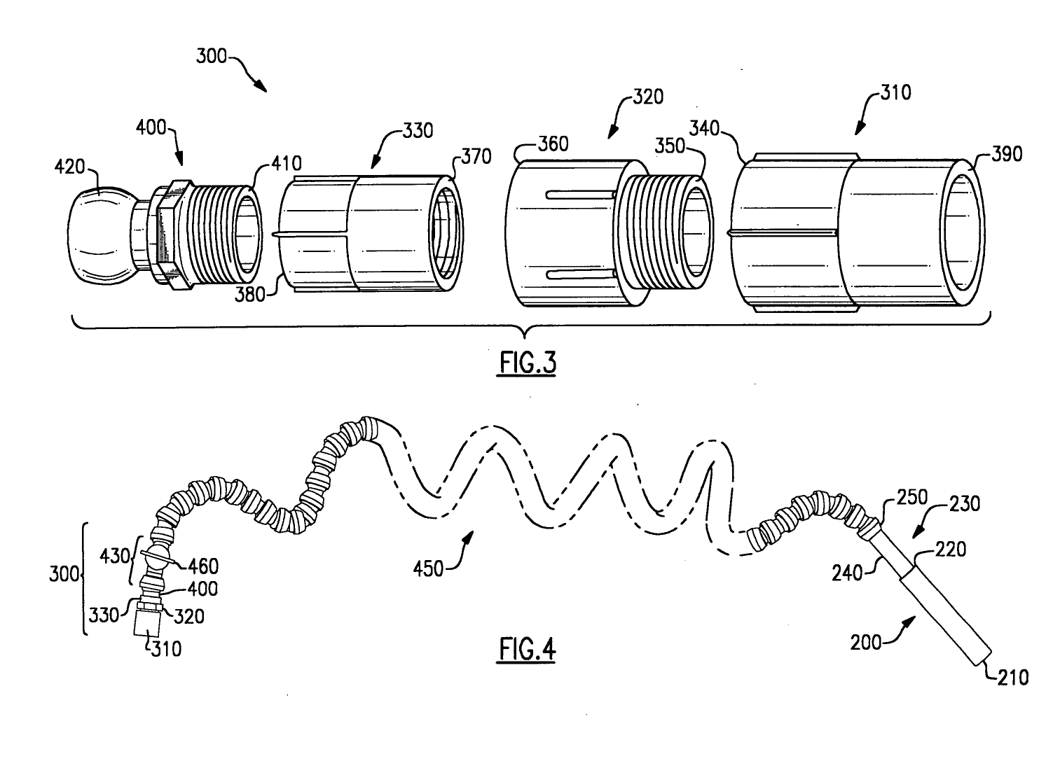

Referring now to FIGS. 3 and 4, an exemplary embodiment of a second, fuel source adapter 300 is shown which is utilized in connection with a metal fuel source canister, such as those chosen (or mandated) for use by commercial vehicle operators (e.g., tow truck drivers) in order to store spare gasoline. An exemplary such metal fuel source canister is a 2.5 gallon red metal J-can gas for gas, which is manufactured by Wedco under part number CAN-80710 and which is commercially available from Midway Auto Supply of Dallas, Tex. USA. It should be noted, however, that this embodiment of the second adapter 300 also can be utilized with other sizes of metal fuel source containers made by other companies as well.

In the FIGS. 3 and 4 embodiment, the fuel source adapter 300 comprises a plurality of adapter elements that are placed into communication with one another and with a hose segment 100. Optionally, one of the adapter elements can be attached to an intermediary element, which, in turn, is attached or connected to an end 110, 120 of a tubing/hose segment 100. As best illustrated in FIG. 3, the adapter elements include first, second and third adapter elements 310, 320, 330, each of which has a lumen (not shown) therewithin to define a fluid pathway therethrough. One end 340 of the first adapter element 310 connects (e.g., by threaded connection or other connection) to one end 350 of the second adapter element 320, wherein the other end 360 of the second adapter element connects (e.g., via slip joint compression connection or other suitable connection) to an end 370 of the third adapter element 330. In accordance with an exemplary embodiment of the present invention, the other end 380 of the third adapter element 330 connects (e.g., via a threaded connection or other suitable connection) to a first end 410 of an intermediary element 400, the second end 420 of which connects (e.g., via a ball and socket connection or other suitable connection) to an end 110, 120 of tubing segment 100. A fluid pathway is defined within a lumen (not shown) between the ends 410, 420 of the intermediary element 400. Optionally, an adhesive can be utilized to strengthen any or all of these connections, wherein suitable such adhesives include but are not limited to Carlon® low VOC solvent cement, which is commercially available under part number VC9LV4 from Lamson & Sessions of Cleveland, Ohio USA.

Once the second adapter 300 is assembled as such, the other end 390 of the first adapter element can be placed in communication with (e.g., connected or attached to) the filler spout (not shown) of a fuel source (e.g., a metal gas can). Thereafter, fuel from the fuel source can be poured (or otherwise emptied or transferred) from the fuel source into the intermediary element 400 and through the fluid pathway defined therein and then into and through the fluid pathways within the second adapter elements 310, 320, 330, and then into and through the fluid pathway within the tubing segment(s) 100 to which the intermediary element is connected. From there, the fuel flows through the fluid pathway defined within each of the other segment(s), if any, in the chain of connected segments, then into and through the fluid pathway within the first, fuel receiving area adapter 200, and finally into the fuel receiving area.

In accordance with an exemplary embodiment of the present invention, and as shown in FIG. 4, a valve element 430 can be disposed between the intermediary element 400 and the segment 100 of hose/tubing to which the intermediary element is attached or connected, wherein, by way of non-limiting example, the valve element includes a socket-type end for connection to the ball-type end of the intermediary element and a ball end for connection to a socket end 110 or 120 of a tubing segment 100. The valve element 430 includes a dial or other movable element 460, which can be turned in order to open or close the valve, and, in doing so, to permit, cease or otherwise influence the flow of fluid within the pathway created between the fuel source and the segment(s) 100 of tubing via the adapter elements 310, 320, 330 and the intermediary element 400. An example of a suitable such valve element 430 is an in line valve, which is commercially available as item number 34038 from Wiha Quality Tools of Monticello, Minn. USA.

FIG. 4 depicts a chain 450 of connected tubing segments of the type shown in FIG. 1 a first, fuel receiving area adapter 200 is attached or otherwise connected to one end of the chain of connected segments and a second, fuel source adapter 300 of the type shown in FIG. 3 is attached or otherwise connected to the other end of the chain of connected segments. FIG. 4 depicts an advantage of the present invention, namely that the chain 450 of connected segments can be expanded to be long and articulatable so as to allow a significant distance between the first and second adapters 200, 300 yet strong enough to prevent the chain of segments 450 from sagging under its own weight. That, in turn, allows one to insert the first adapter 200 into fluid receiving area (e.g., a vehicle fuel tank) and the second adapter 300 into a fuel source (e.g., a gasoline canister) so as to enable one to dispense fuel (e.g., via a gravity fill) from the fuel source into the fuel receiving area while at a distance safely remote from the fuel receiving area. This advantages is shared by all embodiments of the present invention.

In accordance with an exemplary embodiment of the present invention, each of the adapter elements 310, 320, 330 and the intermediary element 400 is made of plastic-based material, wherein such a material can be the same or different. By way of non-limiting example, the adapter elements 310, 320, 330 can be made of a polyvinylchloride (PVC) material, wherein suitable such PVC materials include but are not limited to Carlon® Schedule 40 type PVC material, which is commercially available from Lamson & Sessions of Cleveland, Ohio USA. Also by way of non-limiting example, the intermediary element 400 is made of an acetal-based polymer such as acetal polyoxymethylene, which is commercially manufactured by BASF Corporation of Wyandotte, Wis. USA and sold under the trademark ULTRAFORM®. In accordance with an exemplary embodiment of the present invention in which the fluid is a fuel such as gasoline or diesel fuel, a suitable acetal polyoxymethylene material from which the intermediary element 400 can be made is, by way of non-limiting example, ULTRAFORM® N 2320 003 UNC Q600.

Referring now to FIG. 5, another exemplary embodiment of a second fuel source adapter 500 is shown which, by way of non-limiting example, can be utilized in connection with a plastic gas canister fuel source, such as those used by non-commercial vehicle owners. An exemplary such plastic gas canister is a 2.5 gallon gas can, which is manufactured by Wedco under part number CAN-W220 and which is commercially available from Midway Auto Supply of Dallas, Tex. USA.

In this exemplary embodiment, the fuel source adapter 500 also comprises a plurality of adapter elements that are placed into communication with one another, wherein one of the adapter elements is attached to an intermediary element, which, in turn, is attached or connected to a hose/tubing segment 100. For example, the second adapter 500 can include first and second adapter elements 510, 520, wherein the first adapter element is a joint and the second adapter element is a rimmed element. One end 530 of the first adapter element 510 connects (e.g., via a threaded connection or other suitable connection) to a tubing segment 100 or, as shown in FIG. 5, to a complementary threaded end 610 of an intermediary element 600, the other end 620 of which is connected (e.g., via a ball and socket connection or other suitable connection) to a tubing segment. The other end 540 of the first adapter element 510 connects (e.g., via slip joint compression connection or other suitable connection) to one end 550 of the second, rimmed adapter element 520, wherein the other end 560 of the second adapter element fits within a spout opening of a fuel source (e.g., a plastic gas can) such that the rim portion 570 of the rimmed element is securely yet reversibly fit within the spout opening. Optionally, an adhesive an be utilized to strengthen any or all of these connections, wherein suitable such adhesives include but are not limited to Carlon® low VOC solvent cement, which is commercially available under part number VC9LV4 from Lamson & Sessions of Cleveland, Ohio USA. Once these connections are made, fuel from the fuel source can be poured (or otherwise emptied or transferred) from the fuel source into and through the intermediary element 600 and then into and through each of the second adapter elements 510, 520 and then into the segment(s) 100 of tubing.

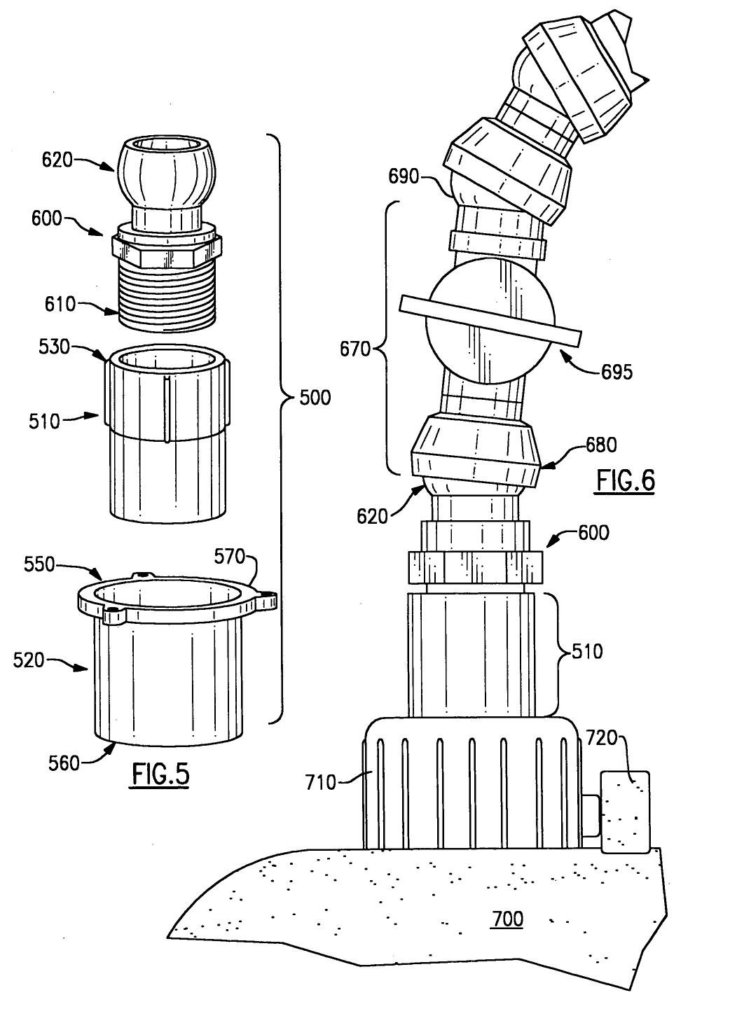

In accordance with an exemplary embodiment of the present invention, and as shown in FIG. 6, a valve element 670 can be disposed between the intermediary element 600 and the segment 100 of hose/tubing to which the intermediary element is attached, wherein, by way of non-limiting example, the valve element includes a socket-type end 680 for connection to the ball-type end 620 of the intermediary element and a ball end 680 for connection to a socket end 110 or 120 of a tubing segment 100. The valve element 670 includes a dial or other movable element 695, which can be turned in order to open or close the valve, and, in doing so, to permit, cease or otherwise influence the flow of fluid within the pathway created between the fuel source and the segment(s) 100 of tubing via the adapter elements 510, 520 and the intermediary element 600. An example of a suitable such valve element 670 is an in line valve, which is commercially available as item number 34038 from Wiha Quality Tools of Monticello, Minn. USA.

In accordance with an exemplary embodiment of the present invention, each of the adapter elements 510, 520 and the intermediary element 600 is made of plastic-based material, wherein such a material can be the same or different. By way of non-limiting example, the adapter elements 510, 520 can be made of a polyvinylchloride (PVC) material, wherein suitable such PVC materials include but are not limited to Carlon® Schedule 40 type PVC material, which is commercially available from Lamson & Sessions of Cleveland, Ohio USA. Also by way of non-limiting example, the intermediary element 606 is made of an acetal-based polymer such as acetal polyoxymethylene, which is commercially manufactured by BASF Corporation of Wyandotte, Wis. USA and sold under the trademark ULTRAFORM®. In accordance with an exemplary embodiment of the present invention in which the fluid is a fuel such as gasoline or diesel fuel, a suitable acetal polyoxymethylene material from which the intermediary element 600 extension spout 230 can be made is, by way of non-limiting example, ULTRAFORM® N 2320 003 UNC Q600.

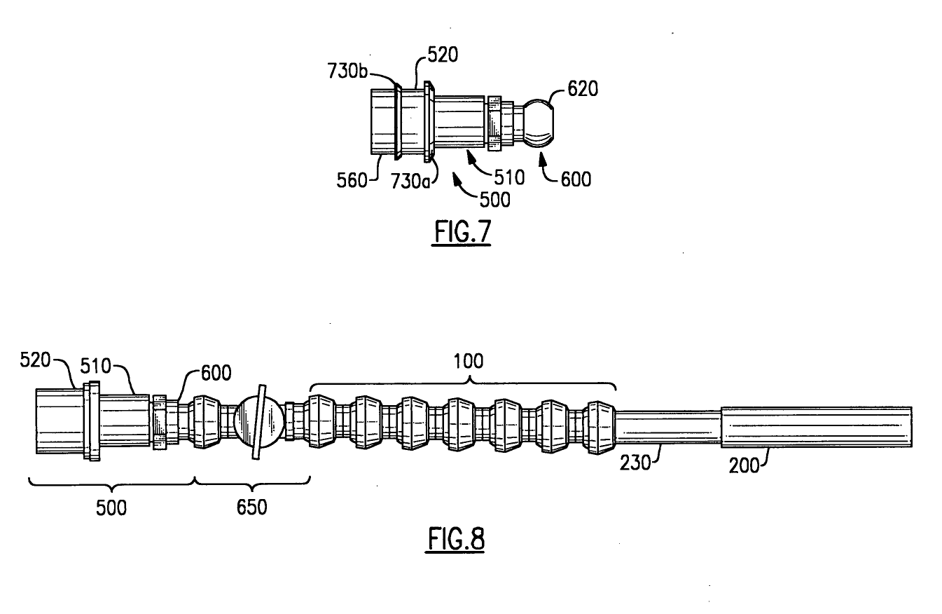

Also in accordance with an exemplary embodiment of the present invention, and as shown in FIG. 6, the second adapter 500 can include one or more additional components for various reasons. By way of non-limiting example, certain fuel sources, such as the plastic gas can 700 shown in FIG. 6, can include child safety features, e.g., a safety clip 710 and clip retainer 720. In accordance with such an embodiment, and as shown in FIG. 7, the second adapter 500 can include one or more seals 730 (e.g., one or more V-shaped O-rings and/or one or more slip joint washers) to fit around the rim portion 570 and/or the main body of the rimmed adapter element 520 of the second adapter 500 to ensure that the system will not interfere with the child safety features of the gas can 700.

FIG. 8 depicts an another exemplary fuel dispensing system in accordance with the present invention. The system includes a tubing segment 100 of the type shown in FIG. 1, wherein a first, fuel receiving area adapter 200 of the type shown in FIG. 4 is attached or otherwise connected to one end of the tubing segment and a second, fuel source adapter 500 of the type shown in FIGS. 5-7 is attached or otherwise connected to the other end of the tubing segments. Although not shown in FIG. 8, it is understood that the depicted system can be comprised of a chain of two or more connected hose/tubing segments 100, as is shown, e.g., in the FIG. 8 exemplary embodiment of the present invention.

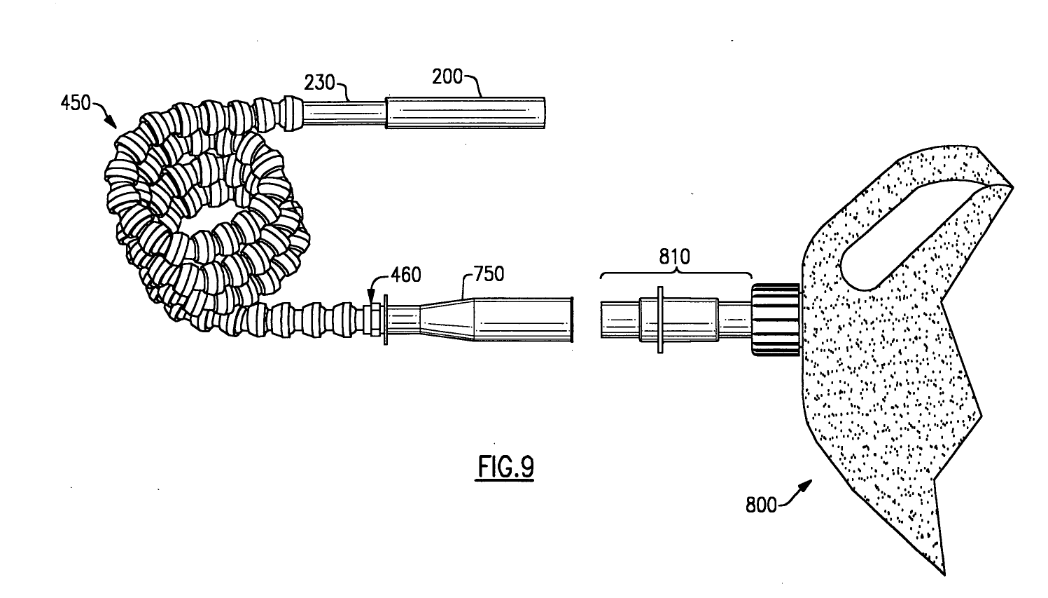

Referring now to FIG. 9, another exemplary embodiment of the present invention is shown and which, by way of non-limiting example, can be utilized in connection with a CARB compliant gas canister fuel source, such as those used in jurisdictions subject to the California Air Resources Board (CARB) emission and spill control regulations. Exemplary CARB compliant gas canisters include, but are not limited to the ECO® line of portable gasoline cans commercially available from Scepter of Scarborough, Ontario CANADA.

In accordance with this exemplary embodiment, a first adapter 200 is included (see FIG. 14B) but not a second adapter. A spout element 750 of a CARB compliant gas can 800 is attached or connected directly to an end 460 of a chain 450 of tubing segments of the type shown in FIG. 1 and FIG. 3. This attachment/connection can be made in various ways (e.g., threadedly); however in accordance with an exemplary embodiment of the present invention it occurs through use of a strong adhesive that will not chemically react with fuel. Suitable such adhesives include, but are not limited to the Automix™ adhesive kit, which is commercially available under part numbers 05883 and 05907 from 3M of St. Paul, Minn. USA. The adhesive is applied within the end 460 of the chain 450 of segments and on either or both of the rim 760 and the portion of the body (not shown) beyond the rim of the spout element 750 that is inserted within the end of the chain. The spout element 750 is then reconnected to the gas can 800 (e.g., at a spout receiving area 810) to enable fuel to be transferred from the gas can, through the spout element, into and through the chain 450 of segments, through the intermediary element 230, into and through the first adapter 200 and into the fuel receiving area (e.g., a vehicle's gasoline tank).

FIG. 9 also depicts yet another advantage of the present invention, namely that the chain of segments 450 can be wound or otherwise bundled into a small, ordered arrangement having a compact shape and size. This advantage is shared by all embodiments of the present invention and is especially beneficial in that it allows for easy storage and transport of the chain of segments 450

In accordance with the present invention, any or all of the components of the above-described systems can be included within a kit. By way of example, such a kit can include some or all of the following components: one or more segments 100, one or more subsegments 130, one or more (sub)segment attachment tools, one or more (sub)segment detachment tools, one or more first adapters 200, one or more second adapters 300 and/or one or more adapter elements 310, 320, 330 of the type shown in FIGS. 3 and 4, one or more second adapters 500 and/or adapter elements 510, 520 of the type shown in FIGS. 5-7, one or more intermediary elements 230 of the type shown in FIG. 4, one or more intermediary elements 400 of the type shown in FIGS. 3 and 4, one or more intermediary elements 600 of the type shown in FIG. 5-7. The kit also can include one or more of the various adhesives discussed herein.

The kit can further include product literature, such as, by way of non-limiting example, an inventory of components list, one or more advertisements, one or more coupons, one or more warranties, and/or instructions for use. Such literature can be provided in the kit as hard copy (e.g., on paper or laminate) and/or as soft copy (e.g., a CD-ROM or another computer readable medium). Also, by way of non-limiting example, the components of the kit can be housed within a container, such as a carrying case.

Although the present invention has been described herein with reference to details of currently preferred embodiments, it is not intended that such details be regarded as limiting the scope of the invention, except as and to the extent that they are included in the following claims—that is, the foregoing description of the present invention is merely illustrative, and it should be understood that variations and modifications can be effected without departing from the scope or spirit of the invention as set forth in the following claims. Moreover, any document(s) mentioned herein are incorporated by reference in their entirety, as are any other documents that are referenced within the document(s) mentioned herein.

We claim:

1. A system for dispensing fuel from a fuel source into a fuel receiving area, comprising:
a plurality of reversibly connected articulatable hose segments, wherein each hose segment has a lumen defining a fluid pathway therein; and
a fuel receiving area adapter attached to a first end of the plurality of hose segments for placement into the fuel receiving area.

2. The system of claim 1, wherein each of the plurality of hose segments is comprised of a plurality of reversibly connected subsegments.

3. The system of claim 2, wherein the plurality of subsegments are reversibly connected to each other via ball and socket connections.

4. The system of claim 1, wherein the plurality of segments are reversibly connected to each other via ball and socket connections.

5. The system of claim 1, wherein the fuel receiving area adapter is a tubular member having a first end, a second end and a lumen, wherein the lumen defines a fluid pathway between the first end and the second end of the fuel receiving area adapter.

6. The system of claim 5, further comprising an intermediary element having a first end, a second end and a lumen, wherein the lumen defines a fluid pathway between the first end and the second end of the intermediary element, and wherein the first end of the intermediary element is connected to the first end of one of the plurality of articulated hose segments and the second end of the intermediary element is adapted to be disposed within the fuel receiving area adapter.

7. The system of claim 6, wherein the first end of the intermediary element is connected to the first end of one of the plurality of articulated hose segments via a ball and socket connection.

8. The system of claim 6, wherein the second end of the intermediary element is connected to the fuel receiving area adapter via an adhesive.

9. The system of claim 1, further comprising a fuel source adapter attached to a second end of the plurality of hose segments an in communication with a fuel source.

10. The system of claim 9, wherein the fuel source adapter is comprised of a plurality of connected adapter elements.

11. The system of claim 9, further comprising an intermediary element having a first end, a second end and a lumen, wherein the lumen defines a fluid pathway between the first end and the second end of the intermediary element, and wherein the first end of the intermediary element is connected to the second end of one of the plurality of articulated hose segments and the second end of the intermediary element is connected to the fuel receiving area adapter.

12. The system of claim 11, further comprising a valve element having a first end, a second end and a lumen, wherein the lumen defines a fluid pathway between the first end and the second end of the valve element, and wherein the first end of the valve element is connected to the first end of the intermediary element and the second end of the valve element is connected to the second end of one of the plurality of articulated hose segments.

13. The system of claim 9, further comprising at least one seal disposed on the second adapter.

14. The system of claim 13, wherein each of the at least one seal is selected from the group consisting of at least one slip joint washer and at least one O-ring.

15. A fuel dispensing kit, comprising:
a plurality of articulatable hose segments, wherein at least some of the plurality of hose segments are adapted to be reversibly connected to one another; and
at least one fuel receiving area adapter attachable to a first end of the plurality of hose segments for placement into a fuel receiving area.

16. The fuel dispensing kit of claim 15, further comprising:
at least one fuel source adapter attachable to a second end of the plurality of hose segments for placement into a fuel source.

17. The fuel dispensing kit of claim 15, further comprising at least one intermediary element adapted to be disposed between the first end of the plurality of hose segments and the fuel receiving area.

18. The fuel dispensing kit of claim 15, further comprising at least one intermediary element adapted to be disposed between the second end of the plurality of hose segments and the fuel source.

19. The fuel dispensing kit of claim 15, further comprising at least one valve element adapted to be disposed between the second end of the plurality of hose segments and the fuel source.

20. The fuel dispensing kit of claim 15, further comprising at least one seal, wherein each of the at least one seal is adapted to be disposed on the second adapter.
